(19) United States
(12) Patent Application Publication
(10) Pub. No.: US 2018/0278976 A1
(43) Pub. Date: Sep. 27, 2018

(54) SYSTEM AND METHOD FOR VIDEO PROCESSING

(71) Applicant: SZ DJI TECHNOLOGY CO., LTD., Shenzhen (CN)

(72) Inventors: Chenglin MAO, Shenzhen (CN); Zisheng CAO, Shenzhen (CN); Linchao BAO, Shenzhen (CN)

(21) Appl. No.: 15/993,038

(22) Filed: May 30, 2018

Related U.S. Application Data
(63) Continuation of application No. PCT/CN2015/096325, filed on Dec. 3, 2015.

(51) Int. Cl. H04N 21/242; H04N 21/218; H04N 21/234

(52) U.S. Cl. CPC H04N 21/242; H04N 21/23418; H04N 21/21805

(57) ABSTRACT

A method of video synchronization includes comparing image data from a reference frame sequence with corresponding image data of a search frame sequence and aligning the search frame sequence with the reference frame sequence based on the comparing.

### CROSS-REFERENCE TO RELATED APPLICATION

This application is a continuation of International Application No. PCT/CN2015/096325, filed on Dec. 3, 2015, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosed embodiments relate generally to image processing and more particularly, but not exclusively, to systems and methods for synchronization of multiple video streams.

### BACKGROUND

Video synchronization is the temporal alignment of different video streams. Video synchronization has many applications. For example, different videos can be taken of a particular event from different vantage points, and the videos can later be synchronized to create a merged view of the event. Video synchronization is difficult to perform manually since the human eye cannot easily distinguish between video frames that are shown at rapid frame rates. Another synchronization technique is time-stamping in which each frame of a video stream is marked with the time at which the frame was taken. Subsequently, frames between different video streams having matching time-stamps can be synchronized. However, time-stamping for video synchronization requires that the imaging devices from which the video streams originate be precisely synchronized and error-free. Time-stamping video synchronization methods often cause error because these criteria are difficult to meet in practice.

In view of the foregoing, there is a need for systems and methods for video synchronization that overcome the problem of present video synchronization methods.

### SUMMARY

In accordance with a first aspect disclosed herein, there is set forth a method of video synchronization, comprising:
comparing image data from a reference frame sequence with corresponding image data of a search frame sequence; and
aligning the search frame sequence with the reference frame sequence based on the comparing.

In accordance with another aspect disclosed herein, there is set forth a video synchronization system, comprising:
one or more sensors configured to receive a first video stream and a second video stream; and
a processor configured to:
   obtain a reference frame sequence from the first video stream and a search frame sequence from the second video stream;
   compare image data from the reference frame sequence with corresponding image data of the search frame sequence; and
   align the search frame sequence with the reference frame sequence based on the compared image data.

In accordance with another aspect disclosed herein, there is set forth an apparatus, comprising a processor configured to:
obtain a reference frame sequence from a first video stream and a search frame sequence from a second video stream;
compare image data from the reference frame sequence with corresponding image data of the search frame sequence; and
align the search frame sequence with the reference frame sequence based on the compared image data.

In accordance with another aspect disclosed herein, there is set forth a computer readable storage medium, comprising:
instruction for comparing image data from a reference frame sequence with corresponding image data of a search frame sequence; and
instruction for aligning the search frame sequence with the reference frame sequence based on the comparing.

In accordance with another aspect disclosed herein, there is set forth a processing system, comprising:
an obtaining module configured for obtaining image data from a reference frame sequence and corresponding image data of a search frame sequence;
a comparing module for comparing the image data from the reference frame sequence with the corresponding image data of the search frame sequence; and
an aligning module for aligning the search frame sequence with the reference frame sequence based on the compared image data.

### BRIEF DESCRIPTION OF THE DRAWINGS

FIG. 1 is an exemplary top level block diagram illustrating an embodiment of a video synchronization system shown in relation to video streams taken of a scene.

FIG. 2 is an exemplary block diagram illustrating an alternative embodiment of the video synchronization system of FIG. 1.

FIG. 3 is an exemplary diagram illustrating an embodiment of a first video stream and a second video stream synchronized using the video synchronization system of FIG. 1.

FIG. 4 is an exemplary flow chart illustrating an embodiment of a method for synchronization of a reference frame sequence with a search frame sequence, wherein frames of the search frame sequence are aligned with frames of the reference frame sequence based on comparison of image data from the reference frame sequence and the search frame sequence.

FIG. 5 is an exemplary diagram illustrating an embodiment of the method of FIG. 4 for aligning the search frame sequence with the reference frame sequence.

FIG. 6 is an exemplary diagram illustrating an alternative embodiment of the method of FIG. 4, wherein reference point sequences are compared to search point sequences for video synchronization.

FIG. 7 is an exemplary flow chart illustrating another alternative embodiment of the method of FIG. 4 for comparing reference point sequences to search point sequences for video synchronization.

FIG. 8 is an exemplary diagram illustrating an alternative embodiment of the video synchronization system of FIG. 1, wherein a first video stream and a second video stream are received from a common imaging device.

FIG. 9 is an exemplary diagram illustrating another alternative embodiment of the method of FIG. 4, wherein reference point sequences comprising pixels of image data are compared to search point sequences comprising pixels of image data for video synchronization.

FIG. 10 is an exemplary flow chart illustrating another alternative embodiment of the method of FIG. 4, wherein reference point sequences comprising pixels of image data are compared to search point sequences comprising pixels of image data for video synchronization.

FIG. 11 is an exemplary block diagram illustrating another alternative embodiment of the video synchronization system of FIG. 1, wherein a first video stream and a second video stream are received from different imaging devices.

FIG. 12 is an exemplary diagram illustrating another alternative embodiment of the method of FIG. 4, wherein reference point sequences comprising features of image data are compared to search point sequences comprising features of image data for video synchronization.

FIG. 13 is an exemplary flow chart illustrating another alternative embodiment of the method of FIG. 4, wherein reference point sequences are obtained by matching features between frames of the reference frame sequence.

FIG. 14 is an exemplary flow chart illustrating another alternative embodiment of the method of FIG. 4, wherein search point sequences comprising search features are matched to corresponding reference point sequences comprising reference features.

FIG. 15 is an exemplary decision flow chart illustrating another alternative embodiment of the method of FIG. 4, wherein video synchronization is performed by maximizing a correlation between corresponding image data of a reference frame sequence and a search frame sequence.

FIG. 16 is an exemplary diagram illustrating another alternative embodiment of the method of FIG. 4, depicting a chart of correlations at different alignments between a reference frame sequence and a search frame sequence.

FIG. 17 is an exemplary diagram illustrating another alternative embodiment of the method of FIG. 4, depicting a chart of correlations at different alignments between a reference frame sequence and a search frame sequence.

FIG. 18 is an exemplary diagram illustrating an embodiment of the video synchronization system of FIG. 1, wherein the video synchronization system is mounted aboard an unmanned aerial vehicle (UAV).

FIG. 19 is an exemplary diagram illustrating an embodiment of a processing system including an obtaining module, a comparing module, and an aligning module for video synchronization.

It should be noted that the figures are not drawn to scale and that elements of similar structures or functions are generally represented by like reference numerals for illustrative purposes throughout the figures. It also should be noted that the figures are only intended to facilitate the description of the illustrative embodiments. The figures do not illustrate every aspect of the described embodiments and do not limit the scope of the present disclosure.

### DETAILED DESCRIPTION OF THE EMBODIMENTS

The present disclosure sets forth systems and methods for synchronizing multiple video streams, overcoming disadvantages of prior video synchronization systems and methods.

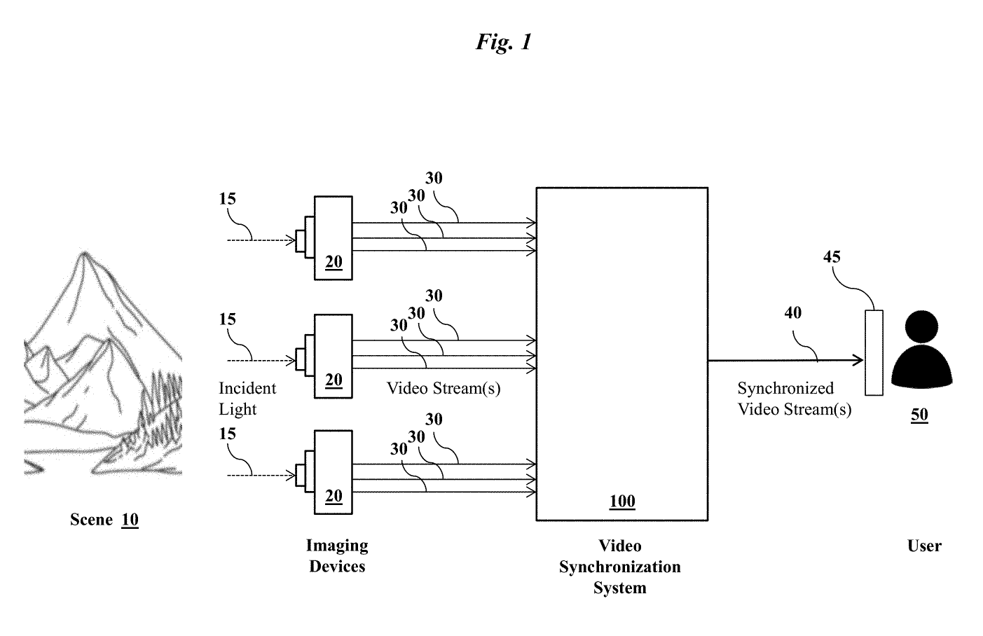

Turning now to FIG. 1, an exemplary top level representation of a video synchronization system 100 is shown in relating to imaging of a scene 10. Incident light 15 from the scene 10 can be captured by one or more imaging devices 20. Each imaging device 20 can receive the incident light 15 from the scene 10 and convert the incident light 15 into digital and/or analog signals. Each imaging device 20 can be, for example, a charge-coupled device (CCD), a complementary metal-oxide-semiconductor (CMOS) device, an N-type metal-oxide-semiconductor (NMOS) device, and hybrids/variants thereof. The imaging devices 20 can include photosensors arranged in a two-dimensional array (not shown) that can each capture one pixel of image information. In some embodiments, each imaging device 20 can have a resolution of, for example, at least 0.05 Megapixels, 0.1 Megapixels, 0.5 Megapixels, 1 Megapixel, 2 Megapixels, 5 Megapixels, 10 Megapixels, 20 Megapixels, 50 Megapixels, 100 Megapixels, or an even greater number of pixels.

Incident light 15 received by the imaging devices 20 can be processed to produce one or more video streams 30. Each imaging device 20 can produce one or more video streams 30 of the scene 10. For example, a selected imaging device 20 can advantageously produce video streams 30 of the scene 10 at multiple different resolutions (for example, a low-resolution video stream 30 and a high-resolution video stream 30), as desired for balancing clarity with efficient for different usages. In some embodiments, the multiple imaging devices 20 can be used to capture video from the scene 10. For example, the multiple imaging devices 20 can capture video streams 30 from multiple different perspectives (or vantage points) of the scene 10. Advantages of using multiple imaging devices 20 can include, for example, enabling panoramic imaging, enabling stereoscopic imaging for depth perception of the scene 10, and/or enabling three-dimensional re-creation of the scene 10. The multiple video streams 30, whether captured by the same imaging device 20 or different imaging devices 20, can each be provided to the video synchronization system 100 for video synchronization.

Exemplary imaging devices 20 suitable for use with the disclosed systems and methods, include, but are not limited to, commercially-available cameras and/or camcorders. Although three imaging devices 20 are shown in FIG. 1 for illustrative purposes only, the video synchronization system 100 can be configured to receive video streams 30 from any number of imaging devices 30, as desired. For example, the video synchronization system 100 can be configured to receive video streams 30 from one, two, three, four, five, six, seven, eight, nine, ten, or even a greater number of imaging devices 20. Likewise the video synchronization system 100 can be configured to receive any number of video streams 30. In some embodiments, synchronization of multiple video streams 30 can be performed with respect to a reference video stream (not shown) that can be successively compared to additional video streams 30. Alternatively, and/or additionally, multiple video streams 30 can be synchronized by merging two synchronized video streams into a merged video stream (not shown). The merged video stream can, in turn, be synchronized and/or merged with additional video streams 30, as desired. After synchronization, the video synchronization system 100 can output one or more synchronized video streams 40. The synchronized video streams 40 can be displayed to a user 50 in any desired manner, for example, through a user interface 45.

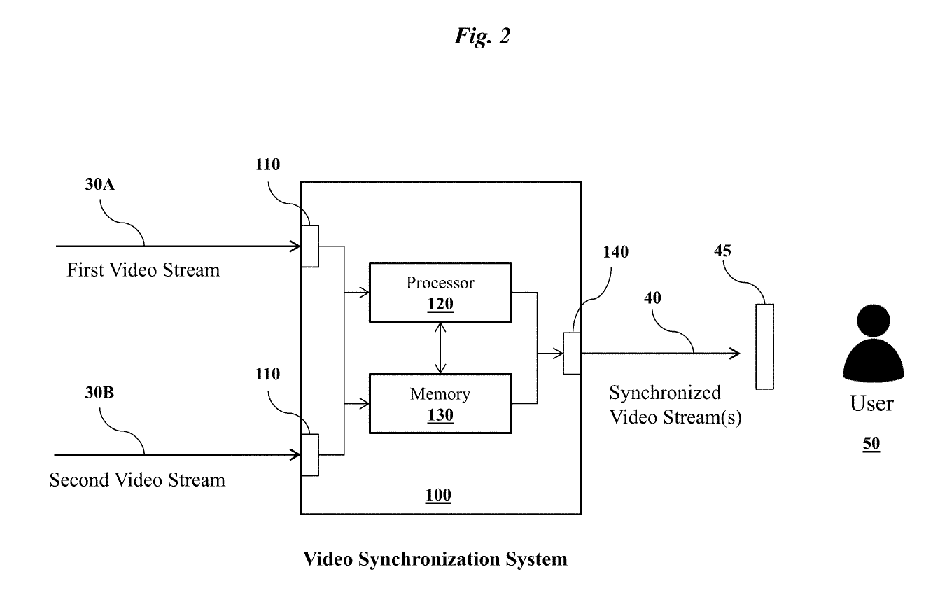

Turning now to FIG. 2, an exemplary embodiment of the video synchronization system 100 of FIG. 1 is shown as synchronizing a first video stream 30A with a second video stream 30B. The first video stream 30A and the second video stream 30B can each feed into the video synchronization system 100 through one or more input ports 110 of the video synchronization system 100. Each input port 110 can receive data (for example, video data) through an appropriate interface, such as a universal serial bus (USB) interface, a digital visual interface (DVI), a display port interface, a serial ATA (SATA) interface, a IEEE 1394 interface (also known as FireWire), a parallel port interface, a serial interface, a video graphics array (VGA) interface, a super video graphics array (SVGA) interface, a small computer system interface (SCSI), a high-definition multimedia interface (HDMI), and/or other standard interface. Alternatively, and/or additionally, the input ports 110 can receive a selected video stream 30A, 30B through a proprietary interface of the video synchronization system 100.

As shown in FIG. 2, the video synchronization system 100 can include one or more processors 120. Although a single processor 120 is shown for illustrative purposes only, the video synchronization system 100 can include any number of processors 120, as desired. Without limitation, each processor 120 can include one or more general purpose microprocessors (for example, single or multi-core processors), application-specific integrated circuits (ASIC), field-programmable gate arrays (FPGA), application-specific instruction-set processors, digital signal processing units, coprocessors, network processing units, audio processing units, encryption processing units, and the like. In certain embodiments, the processor 120 can include an image processing engine or media processing unit, which can include specialized hardware for enhancing the speed and efficiency of focusing, image capture, filtering, Bayer transformations, demosaicing operations, noise reduction operations, image sharpening operations, image softening operations, and the like. The processors 120 can be configured to perform any of the methods described herein, including but not limited to a variety of operations relating to video synchronization. In some embodiments, the processors 120 can include specialized software and/or hardware for processing operations relating to video synchronization—for example, comparing image data from different video streams and ordering frames from the different video streams to synchronize the video streams.

As shown in FIG. 2, the imaging system 100 can include one or more memories 130 (alternatively referred to herein as a computer readable storage medium). Suitable memories 130 can include, for example, random access memory (RAM), static RAM, dynamic RAM, read-only memory (ROM), programmable ROM, erasable programmable ROM, electrically erasable programmable ROM, flash memory, secure digital (SD) card, and the like. The memory 130 can be used to store, for example, image data of the first video stream 200 or the second video stream 300, as well as intermediate processing data (not shown) described below. Furthermore, instruction for performing any of the methods described herein can be stored in the memory 130. The instructions can subsequently be executed by the processors 120. Video streams from the input ports 110 can be placed in communication with the processors 120 and/or the memories 130 via any suitable communication device, such as a communications bus. Similarly, data from the processors 120 and/or the memories 130 can be communicated with one or more output ports 140. The output ports 140 can each have a suitable interface, as described above with respect to the input ports 110. For example, one or more synchronized video streams 40 can be delivered out of the output ports 140 for display to a user 50.

The video synchronization system 100 can include one or more additional hardware components (not shown), as desired (for example, input/output devices such as buttons, a keyboard, keypad, trackball, displays, and/or a monitor). Input/output devices can be used to provide a user interface 45 for interacting with the user 50 to synchronize the video streams 30A and 30B and to view one or more synchronized video stream(s) 40. Various user interface elements (for example, windows, buttons, menus, icons, pop-ups, tabs, controls, cursors, insertion points, and the like) can be used to interface with the user 50.

In some embodiments, the video synchronization system 100 can be configured to send and receive video data remotely. Various technologies can be used for remote communication between the video synchronization system 100, the imaging devices 20, and the user 50. Suitable communication technologies include, for example, radio, Wireless Fidelity (Wi-Fi), cellular, satellite, and broadcasting.

In some embodiments, components of the video synchronization system 100 described herein can be components of a kit (not shown) for assembling an apparatus (not shown) for video synchronization. The processors 120, memories 130, input ports 110, output ports 140, and/or other components, can mutually be placed in communication, either directly or indirectly, when the apparatus is assembled.

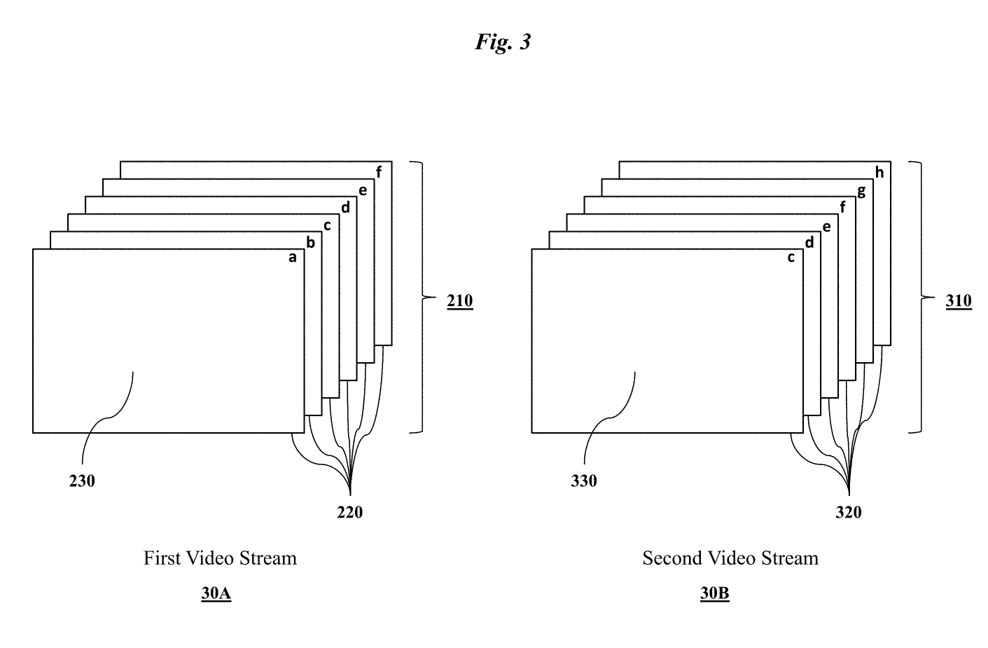

Turning now to FIG. 3, an exemplary first video stream 30A is shown as having a reference frame sequence 210. The reference frame sequence 210 is an ordered set of reference frames 220 of the first video stream 30A. The reference frame sequence 210 represents a sequence of reference frames 220 that can be used as reference against which frames of other video streams can be compared to and/or ordered against. Each reference frame 220 of the reference frame sequence 210 includes reference image data 230 that is a snapshot of the first video stream 30A at a particular time. The reference frame sequence 210 can include all, or some of, the reference frames 220 of the first video stream 30A. Each reference frame 220 is offset from consecutive reference frames 220 by a particular time interval based on the frame rate and/or frame frequency of the first video stream 30A. Exemplary frame rates for the present video synchronization systems and methods can range from, for example, 5 to 10 frames per second, 10 to 20 frames per second, 20 to 30 frames per second, 30 to 50 frames per second, 50 to 100 frames per second, 100 to 200 frames per second, 200 to 300 frames per second, 300 to 500 frames per second, 500 to 1000 frames per second, or an even greater frame rate. In some embodiments, the frame rate can be about 16 frames per second, 20 frames per second, 24 frames per second, 25 frames per second, 30 frames per second, 48 frames per second, 50 frames per second, 60 frames per second, 72 frames per second, 90 frames per second, 100 frames per second, 120 frames per second, 144 frames per second, or 300 frames per second.

FIG. 3 further shows an exemplary second video stream 30B as having a search frame sequence 310. The search frame sequence 310 is an ordered set of search frames 320 of the second video stream 30B. The search frame sequence 310 represents a sequence of search frames 320 that can be ordered (and/or reordered) according to image data 330 of the reference frame sequence 210. Each search frame 320 of the search frame sequence 310 includes search image data 330 that is a snapshot of the second video stream 30B at a particular time. The search frame sequence 310 can include all, or a portion of, the search frames 320 of the second video stream 30B. Within the search frame sequence 310, each search frame 320 is offset from consecutive search frames 320 by a particular time interval based on the frame rate and/or frame frequency of the second video stream 30B. The search frame sequence 310 can have any frame rate described above with respect to the reference frame sequence 210. In some embodiments, the search frame sequence 310 can have the same frame rate as the reference frame sequence 210. In some embodiments, the search frame sequence 310 can have substantially the same frame rate as the reference frame sequence 210—that is, the frame rate of the search frame sequence 310 can be within, for example, 0.1 percent, 0.2 percent, 0.5 percent, 1 percent, 2 percent, 5 percent, 10 percent, 20 percent, 50 percent, or 100 percent of the frame rate of the reference frame sequence 210.

In some embodiments, the search frame sequence 310 can have a different frame rate as the reference frame sequence 210. Where the search frame sequence 310 has a different frame rate as the reference frame sequence 210, the search frame sequence 310 can be aligned with the reference frame sequence 210 based on the frame rates. For example, if the reference frame sequence 210 has a frame rate of 50 frames per second, and the search frame sequence 310 has a frame rate of 100 frames per second, every other frame 320 of the search frame sequence 310 can be aligned with every frame 220 of the reference frame sequence 210.

To illustrate the present video synchronization systems and methods, each reference frame 220 of the reference frame sequence 210 is marked with a letter (a-e) that indicates the content of each reference frame 220. Similarly, each search frame 320 of the search frame sequence 310 is marked with a letter (c-g) that indicates the content of each search frame 310. The frames 220, 320 that are marked with corresponding letters represent images take of a particular scene 10 (shown in FIG. 1) at the same or substantially similar time. Respective image data 230, 330 of the marked frames 220, 320 will therefore mutually correspond. Therefore, aligning the marked frames 220, 320 will result in synchronization with respect to these frames. If the reference frame sequence 210 and the search frame sequence 310 are captured by a common imaging device 20 (shown in FIG. 1), corresponding marked frames 220, 320 will show similar images at similar positions. If the reference frame sequence 210 and the search frame sequence 310 are captured by different imaging devices 20, the images of the frames 220, 320 can include corresponding features that can be positionally offset from one another, depending on the vantage points of the imaging devices 20.

In the example of FIG. 3, to synchronize the reference frame sequence 210 and the search frame sequence 310, the order of search frames 320 of the search frame sequence 310 can be changed until the corresponding marked frames 220 and 320 are temporally aligned. Generally, each reference frame 220 of the reference frame sequence 210 can be aligned with a corresponding search frame 320 of the search frame sequence 310. In some embodiments, the search frame sequence 310 has the same relative frame order as the reference frame sequence 210, but is offset by a certain number of frames. In such cases, the offset can be found by alignment of a single reference frame 220 of the reference frame sequence 210 with a single search frame 320 of the search frame sequence 310. Based on the offset, the entire reference frame sequence 210 is synchronized with the entire search frame sequence 310.

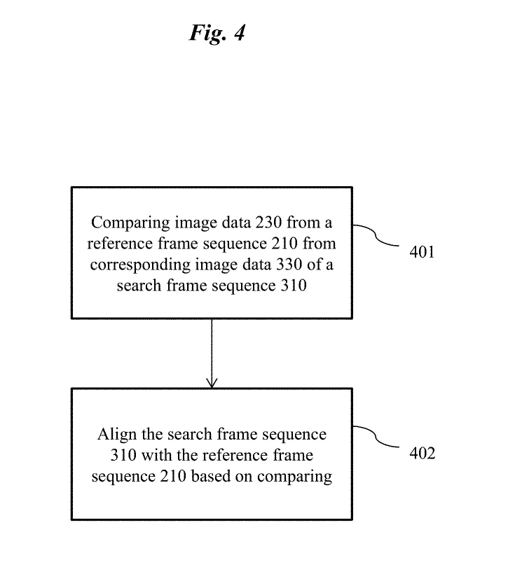

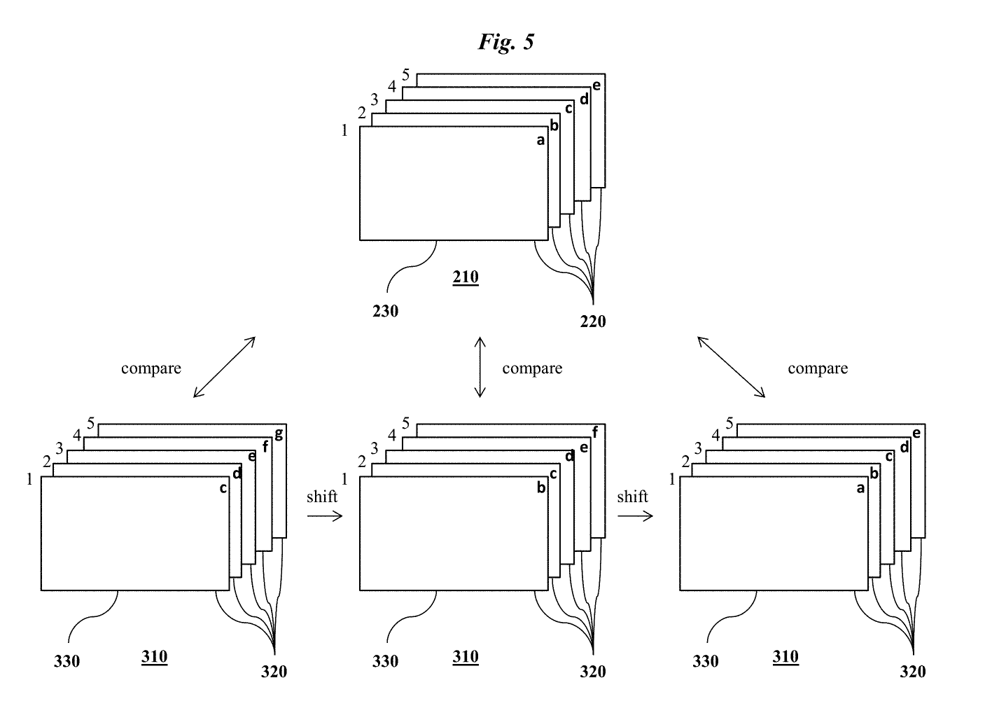

Turning now to FIG. 4, an exemplary method 400 for synchronizing video is shown. At 401, image data 230 from a reference frame sequence 210 is compared to corresponding image data 330 from a search frame sequence 310. At 402, the search frame sequence 310 is aligned with the reference frame sequence 210 based on the comparison. The method 400 for aligning the reference frame sequence 210 and the search frame sequence 310 is further illustrated in FIG. 5. The reference frame sequence 210 is shown at the top of FIG. 5 as having five reference frames 220 marked with letters a-e at positions 1-5, respectively. The bottom of FIG. 5 shows a search frame sequence 310 having five search frames 320 in three different orderings. The search frame sequence 310 initially has search frames 320 marked c-g at positions 1-5, respectively.

To synchronize the reference frame sequence 210 with the search frame sequence 310, image data 330 of the each search frame 320 can be compared with image data 230 of the reference frame 220 at each of the corresponding positions 1 through 5. A numerical value, such as a correlation, can be used to quantitate the comparison between the image data 230 and 330. The alignment of the search frame sequence 310 with the reference frame sequence 210 can then be shifted (or re-ordered). For example, the search frames 320 of the search frame sequence 310 can shifted by a single frame position, such that the search frames 320 b-f now occupy positions 1-5, respectively. After the shift, image data 330 of the search frame sequence 310 can again be compared to and quantitated against the image data 230 of the reference frame sequence 210. Re-ordering of the search frame sequence 310 can be repeated as needed. For example, as shown in FIG. 5, the search frame sequence 310 can be re-aligned with the reference frame sequence 210 by again shifting each of the search frames 320 by a single frame position, such that search frames 320 a-e now occupy positions 1-5, respectively. In this example, search frames 320 a-e are now aligned with reference frames 220 a-e at positions 1-5, yielding an optimal alignment.

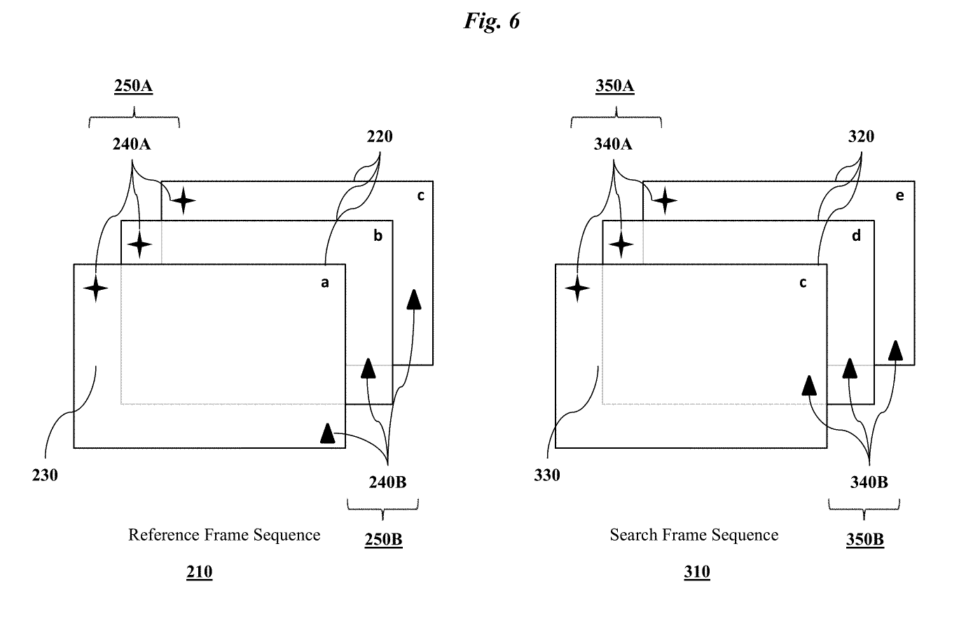

Turning now to FIG. 6, further details are shown for comparing image data 230 of a reference frame sequence 210 to image data 330 of a search frame sequence 310 based on sequences of points, or point sequences, among frames. On the left side of FIG. 6, each reference frame 220 of the reference frame sequence 210 is shown as including a plurality of first reference points 240A (illustrated as star shapes) and second reference points 240B (illustrated as triangular shapes). The reference points 240A collectively form a first reference point sequence 250A. Similarly, the reference points 240B collectively form a second reference point sequence 250B. Each reference point sequence 250 is a collection of matching reference points 240 from one or more reference frames 220 of the reference frame sequence 210. Multiple reference point sequences 250 can be derived from a single reference frame sequence 210. Similarly, as shown on the right side of FIG. 6, each search frame 320 of the search frame sequence 210 can include a plurality of search points 340A, 340B that collectively form search point sequences 350A, 350B, respectively. Each search point sequence 350 is a collection of matching search points 340 from one or more search frames 320 of the search frame sequence 310. Multiple search point sequences 350 can be derived from a single search frame sequence 310.

In some embodiments, each reference point sequence 250 can include one reference point 240 from each of the reference frames 220 of the reference frame sequence 210. Stated somewhat differently, if the reference frame sequence 210 includes one hundred frames, a reference point sequence 250 derived from that reference frame sequence 210 can have one hundred reference points 240, one reference point 240 from each reference frame 220. In some embodiments, each reference point sequence 250 can include one reference point 240 from some, but not all, of the reference frames 220 of the reference frame sequence 210. For example, the reference point sequence 250 can include one reference point 240 from each of the first fifty of one hundred reference frames 220, from each of every other reference frames 220, or from each of certain randomly pre-selected reference frames 220 (for example, frames 1, 5, 9, and 29) (not shown in FIG. 6).

Likewise, in some embodiments, each search point sequence 350 can include one search point 350 from each of the search frames 320 of the search frame sequence 310. In some embodiments, each search point sequence 350 can include one search point 340 from some, but not all, of the search frames 320 of the search frame sequence 310. In some embodiments, the search point sequence 350 can be selected based on the frames of a corresponding reference point sequence 250. For example, if the corresponding reference point sequence 250 includes one reference point 240 from each of reference frame numbers 2, 5, 10, 18, and 26, the search point sequence 350 can include one search point 340 from each of search frame numbers 2, 5, 10, 18, and 26 (not shown in FIG. 6). In some embodiments, the search point sequence 350 can be selected based on a relative frame order of frames of the corresponding reference point sequence 250. Referring again to the example in which the corresponding reference point sequence 250 includes one reference point 240 from each of reference frame numbers 2, 5, 10, 18, and 26, the search point sequence 350 can include one search point 340 from each of search frame numbers 3, 6, 11, 19, and 27, or with other similar frame offsets. Where the search frame sequence 310 has a different frame rate as the reference frame sequence 210, the search point sequence 350 can be selected with respect to the reference point sequence 250 based on the frame rates.

The reference points 240 and corresponding search points 340 can be selected as appropriate for comparing the reference frame sequence 210 and the search frame sequence 310. In some embodiments, each reference point 240 and search point 340 is a single image pixel. In other embodiments, each reference point 240 and search point 340 is a group of one or more pixels that comprise a feature.

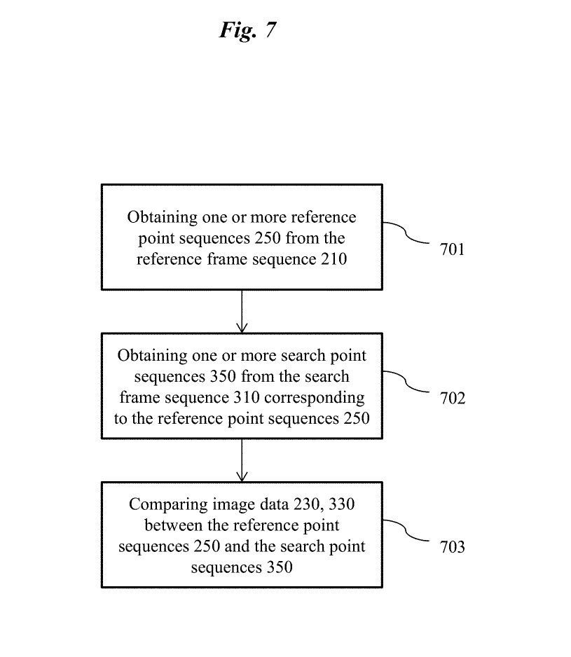

Turning now to FIG. 7, an exemplary method 700 for video synchronization is shown for comparing a reference frame sequence 210 with a search frame sequence 310. At 701, one or more reference point sequences 250 are obtained from the reference frame sequence 210. As described above with reference to FIG. 6, each reference point sequence can include a reference point 240 from each of a plurality of reference frames 220 of the reference frame sequence 210. The number of reference point sequences 250 to be obtained from the reference frame sequence 210 can vary depending on the circumstances. For example, the number of reference point sequences 250 obtained can be in proportion to the size or resolution of the image data 230 (shown in FIG. 2) of the reference frame sequence 210. Using more reference point sequences 250 for comparison can be advantageous for larger and higher resolution video frames; whereas, using fewer reference point sequences 250 may conserve computational resources for smaller and lower resolution video frames. In some embodiments, the number of reference point sequences 250 obtained can be in proportion to the complexity of the image data 230. That is, a low complexity image (for example, an image of a uniform horizon with a few features such as the sun) can require fewer reference point sequences than a high complexity image (for example, an image of a safari having a large number of distinct animals). A suitable quantitative measure of complexity of the image data 230, such as entropy or information content, can be used to determine the number of reference point sequences 250 to obtain.

At 702, one or more search point sequences 350 that correspond to the reference point sequences 250 can be obtained from the search frame sequence 310. In some embodiments, one search point sequence 350 can be obtained for each reference point sequence 250. In some embodiments, one search point sequence 350 can be obtained for fewer than all of the reference point sequences 250. That is, for one or more reference point sequences 250, a corresponding search point sequence 350 cannot be located. Reference point sequences 250 without any corresponding search point sequence 350 can optionally be excluded from any subsequent comparison.

Obtaining a corresponding search point sequence 350 based on a reference point sequence 250 can be performed in various ways. In some embodiments, a corresponding search point sequence 350 can be obtained based on coordinates of reference points 240 (shown in FIG. 6) of the reference point sequence 250. The corresponding search point sequence 350 can be obtained based on having search points 340 (shown in FIG. 6) with the same or similar coordinates as the reference points 240. For example, with respect to a reference point sequence 250 in which reference points 240 are located at coordinates (75, 100), (85, 100), and (95, 100) of the reference frames 220, a search point sequence 350 that is located at coordinates (75, 100), (85, 100), and (95, 100) of the search frames 320 will be found as the corresponding search point sequence 350. In some embodiments, the corresponding search point sequence 350 can be obtained based on image data 230 of the reference points 240 of the reference point sequence 250. The corresponding search point sequence 350 can be obtained based on having search points 340 with the same or similar image data 230 as the reference points 240. For example, reference point sequence 250 having reference points 240 with red/green/blue (RGB) values of (50, 225, 75), (78, 95, 120), (75, 90, 150) can be found to correspond with a search point sequence 350 having search points 340 with the same or similar RBG values.

At 703, image data 230 from the reference point sequences 250 can be compared to image data 330 from corresponding search point sequences 350. In some embodiments, the comparison between the image data 230 and 330 can be based on an intensity of one or more corresponding pixels of the image data 230, 330. In some embodiments, the image data 230, 330 will be mosaic image data (for example, a mosaic image created through a color filter array) wherein each pixel has a single intensity value corresponding to one of a red, green, or blue channel. In such embodiments, mosaic image data 230, 330 of the reference frame sequence 210 and the search frame sequence 310, respectively, can be compared to obtain a frame order for video synchronization. An advantage of comparing mosaic image data is that de-mosaicing operations can initially be avoided for pre-synchronization video streams and subsequently performed for synchronized or merged video streams, resulting in efficiency gains. In some embodiments, the image data 230, 330 is non-mosaic image data (for example, image data that has already undergone de-mosaicing), in which case the non-mosaic image data 230 of the reference frame sequence 210 can be compared to non-mosaic image data 330 the search frame sequence 310.

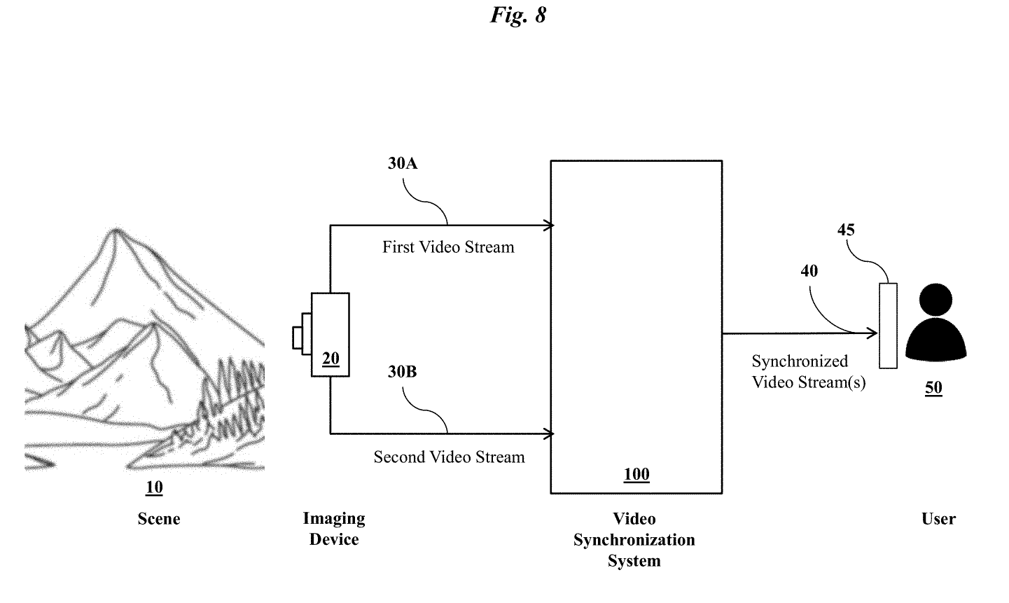

Turning now to FIG. 8, an exemplary embodiment of the video synchronization system 100 of FIG. 1 is shown has having a first video stream 30A and second video stream 30B originate from a common imaging device 20. The first and second video streams 30A, 30B can depict a scene 10. In some embodiments, the first and second video streams 30A, 30B can be taken at the same time, though formatted differently. For example, the first video stream 30A can include high-resolution images of the scene 10, whereas the second video stream 30B can include low-resolutions images of the scene 10. Examples of applications of synchronizing the first and second video streams 30A, 30B include rapid video editing, which includes applying a sequence of editing operations to one or more frames of a frame sequence. The sequence of editing operations can advantageously be determined on a low resolution video stream, and that sequence of editing operations can be subsequently applied to a synchronized high resolution video stream. Since the first and second video streams 30A, 30B originate from the same imaging device 20 and depict the same scene 10, corresponding features appear at the same locations in the first and second video streams 30A, 30B. Accordingly, search points 340 (shown in FIG. 6) that correspond to particular reference points 240 (shown in FIG. 6) and can be determined based on coordinates of the reference points 240.

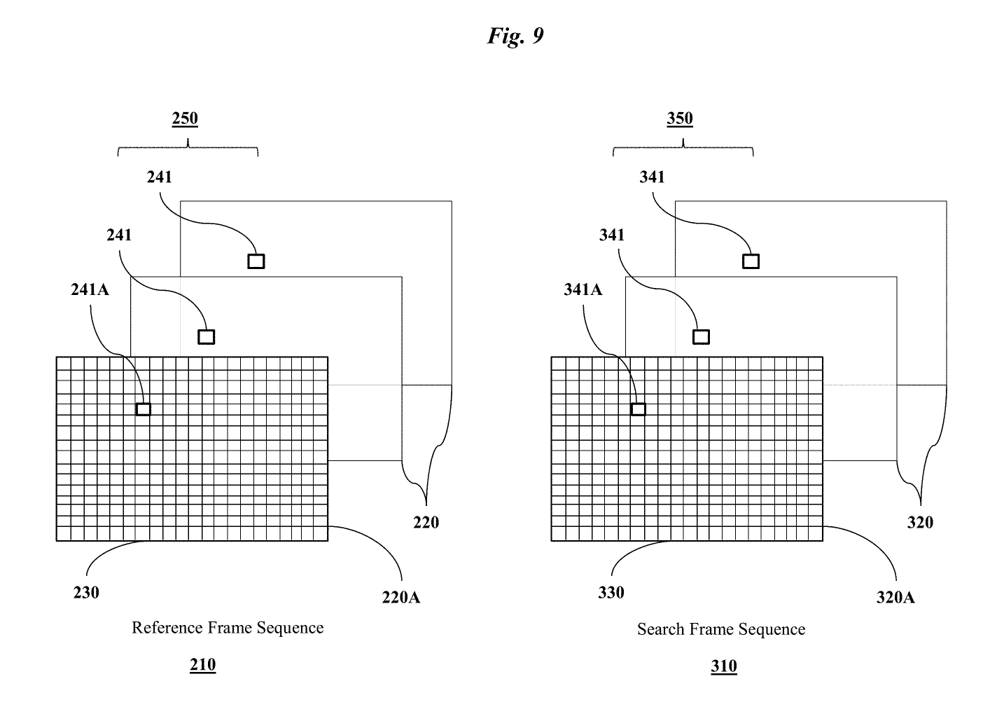

Turning now to FIG. 9, an exemplary diagram is shown for video synchronization, wherein comparison of a reference frame sequence 210 to a search frame sequence 310 is based on respective reference pixels 241 and search pixels 341. Each reference frame 220 of the reference frame sequence 210 can be composed of a plurality of reference pixels 241. Each reference pixel 241 can display a discrete unit of the reference images 230. Similarly, each search frame 320 of the search frame sequence 310 can be composed of a plurality of search pixels 341. Each search pixel 341 can display a discrete unit of the search images 330. In some embodiments, as shown in FIG. 9, a reference point sequence 250 can include a plurality of reference pixels 241. For example, the reference point sequence 250 can include one reference pixel 241 from each of one or more reference frames 220. Likewise, a search point sequence 350 can include a plurality of search pixels 241. For example, the search point sequence 350 can include one search pixel 341 from each of one or more search frames 320.

As shown in FIG. 9, a reference point sequence 250 can be determined based on a selected reference pixel 241A of a selected reference frame 220A. The selected reference pixel 241A can be an initial element of the reference point sequence 250. Additional reference pixels 241 that match the selected reference pixel 241A in additional reference frames 220 can be added to the reference point sequence 250. The additional reference pixels can be added according to a location of the selected reference pixel 241. Similarly, a search point sequence 350 can be determined based on a selected search pixel 341A of a selected search frame 320A. The selected search pixel 341A can be an initial element of the search point sequence 350 that is selected based on a location of the selected reference pixel 241A. Additional search pixels 341 that match the selected search pixel 341A in additional search frames 320 can be added to the search point sequence 350. The additional search pixels can be added according to a location of the selected search pixel 341. Overall, the location of the search point sequence 350 on the search frames 320 can correspond to the location of the reference point sequence 250 on the reference frames 220.

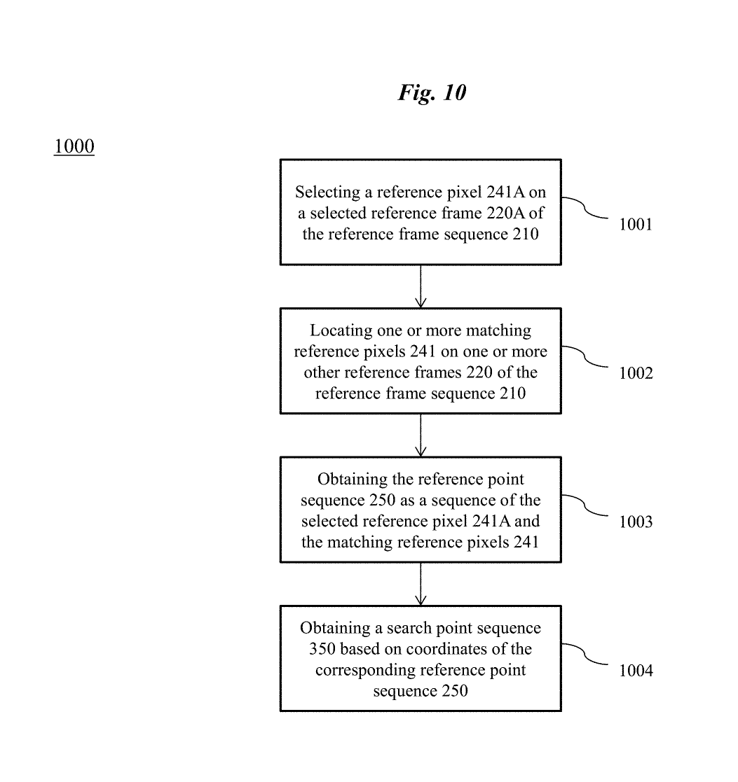

Accordingly, turning now to FIG. 10, an exemplary method 1000 is shown for video synchronization that is based on comparing reference pixels 241 of the reference frame sequence 210 to search pixels 341 of the search frame sequence 310. At 1001, a reference pixel 241A is selected on a selected reference frame 220A of the reference frame sequence 210. The reference pixel 241A can be selected on the selected reference frame 220A using any suitable method. The selected reference pixel 241A can be used to form a corresponding reference point sequence 250 for video synchronization. The selection of the reference pixel 241A and corresponding reference point sequences 250 can be repeated as desired.

In some embodiments, reference pixels 241 (and corresponding reference point sequences 250) can be selected in a grid pattern on each of the reference frames 220. For example, the reference pixels 241 can spaced 1 pixel, 2 pixels, 3 pixels, 4 pixels, 5 pixels, 7 pixels, 10 pixels, 20 pixels, 30 pixels, 40 pixels, 50 pixels, 70 pixels, 100 pixels, 200 pixels, 300 pixels, 400 pixels, 500 pixels, or more apart from one another. The spacing of the grid pattern in the horizontal coordinate of the reference frames 220 can be the same or different from the spacing of the grid pattern in the vertical coordinate of the reference frames 220. In other embodiments, reference pixels can (and corresponding reference point sequences 250) can be selected in a random pattern (for example, using a Monte Carlo method). As described above with reference to reference point sequences 250 in FIG. 7, the number of reference pixels 241 (and corresponding reference point sequences 250) that are selected can vary depending on the size and complexity of the reference frames 220. For example, the number of reference pixels 241 that are selected can be from 1 to 5 pixels, 2 to 10 pixels, 5 to 10 pixels, 10 to 50 pixels, 20 to 100 pixels, 50 to 100 pixels, 100 to 500 pixels, 200 to 1000 pixels, 500 to 1000 pixels, 1000 to 5000 pixels, 2000 to 10,000 pixels, 5000 to 10,000 pixels, 10,000 to 50,000 pixels, 20,000 to 100,000 pixels, 50,000 to 100,000 pixels, or even more.

In some embodiments, the reference pixels 241 (and corresponding reference point sequences 250) can advantageously be selected toward the center of the reference frames 220 to avoid edge artifacts. For example, each frame can undergo dewarp operations that can cause image artifacts that frame edges. In some embodiments, the reference pixels 241 (and corresponding reference point sequences 250) can advantageously be selected from the center 1 percent, 2 percent, 5 percent, 10 percent, 15 percent, 20 percent, 25 percent, 30 percent, 40 percent, 50 percent, 60 percent, 70 percent, 80 percent, or 90 percent of pixels of the reference frames 220.

At 1002, one or more matching reference pixels 241 are located on one or more other reference frames 220 (that is, other than the selected reference frame 220A) of the reference frame sequence 210. The matching reference pixels 241 can be located based on coordinates of the selected reference pixel 241A. For example the matching reference pixels 241 can be selected at the same coordinates of each of the respective reference frames 220. Alternatively, the matching reference pixels 241 can be selected at offset coordinates of each of the respective reference frames 220. At 1003, a reference point sequence 250 can be obtained as a sequence of the selected reference pixel 241A and the matching reference pixels 241. Finally, at 1004, a search point sequence 350 can be obtained based on coordinates of the corresponding reference point sequence 250 (for example, either at the same coordinates or at offset coordinates).

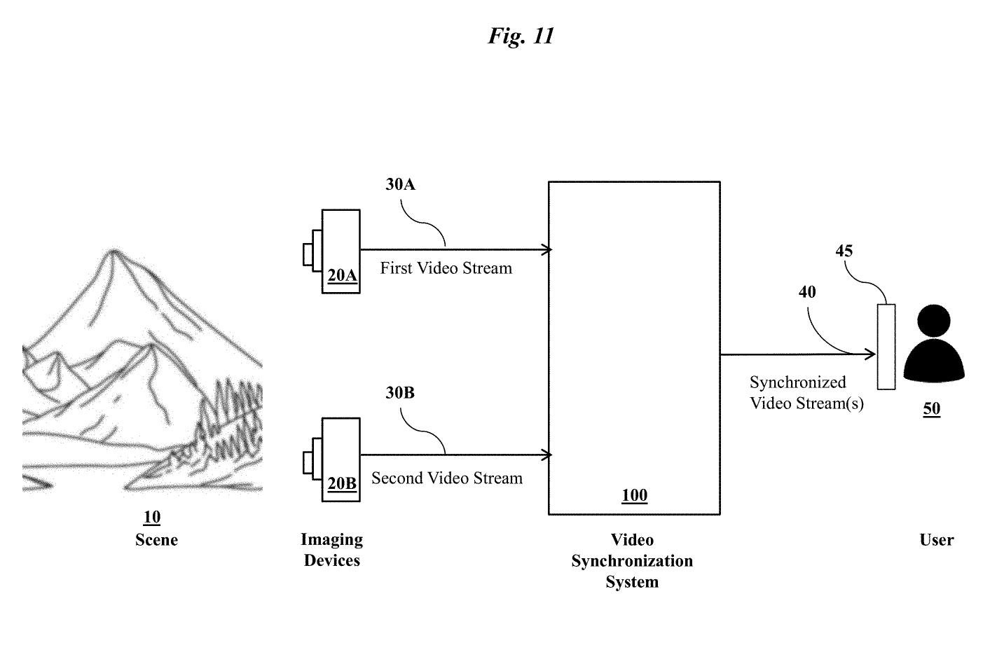

Turning now to FIG. 11, an exemplary embodiment of the video synchronization system 100 of FIG. 1 is shown has having a first video stream 30A and second video stream 30B that originate from different imaging devices 20A, 20B. The first and second video streams 30A, 30B can depict a scene 10 from different vantage points of respective imaging devices 20A, 20B. In some embodiments, the first and second video streams 30A, 30B can be taken at the same time or at overlapping times. The first and second video streams 30A, 30B are inputted into the video synchronization system 100, and one or more synchronized video streams 40 are subsequently outputted from the video synchronization system 100 and directed for view by a user 50. Examples of applications of synchronizing video streams take by different imaging devices 20A, 20B include panoramic imaging, three-dimensional imaging, stereovision, and others. Video synchronization of video streams from different imaging devices poses different challenges from synchronization of video streams from the same imaging device, since features of images taken from different perspectives need to be matched together.

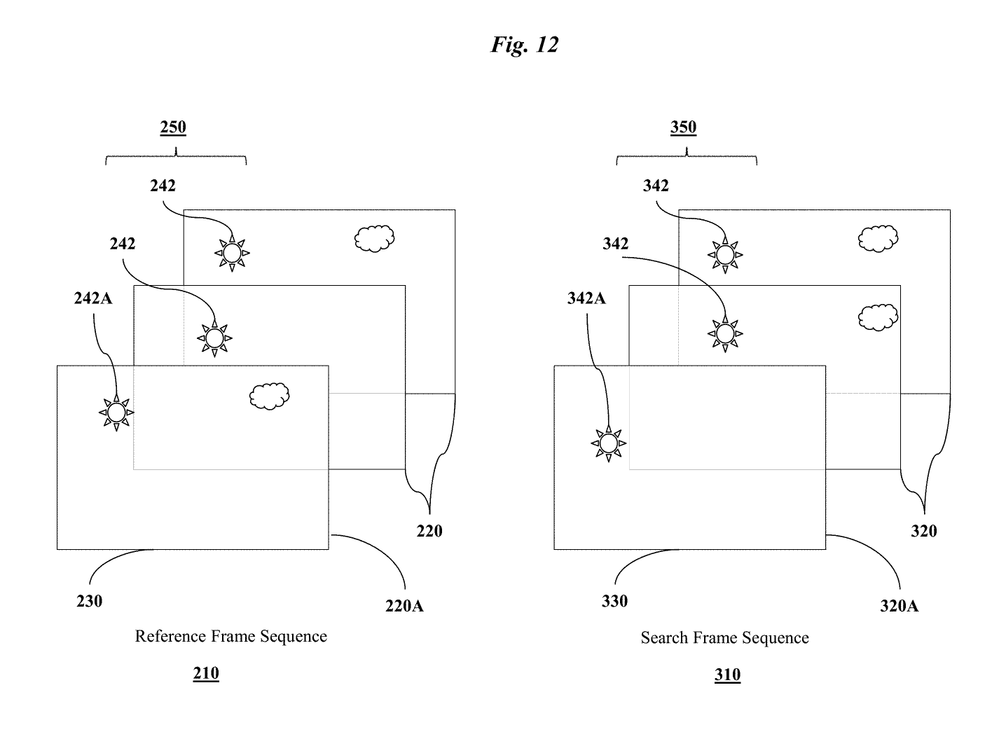

Accordingly, turning now to FIG. 12, an exemplary diagram is shown for synchronization of a reference frame sequence 200 and search frame sequence 300 that are taken by different imaging devices 20 (shown in FIG. 11). Each reference frame 220 can include one or more reference features 242. A reference feature 242 includes a portion of the reference image 230 that, typically, is visually distinguishable from surroundings of the reference feature 242. A reference feature 242 can be a single pixel or multiple pixels of the reference image 230, depending on the composition of the reference image. For example, a reference feature 242 in a reference image 230 of a clear skyline might include an image of the sun or clouds. A sequence of corresponding reference features 242 in one or more of the reference frames 220 makes up a reference point sequence 250. For example, as shown in FIG. 12, the reference features 242 include an image of the sun in each of three successive reference frames 220. The sun portions of the images 230 of the reference frames 220 make up the reference point sequence 250. The reference point sequence 250 can be obtained by selecting a reference feature 242A in a selected reference frame 220A, followed by adding matching reference features 242 in other reference frames 220.

Similarly, FIG. 12 shows that each search frame 320 can include one or more search features 342. A search feature 342 includes a portion of the search image 330 that, typically, is visually distinguishable from surroundings of the search feature 342. A search feature 342 can be a single pixel or multiple pixels of the search image 330, depending on the composition of the search image 330. A sequence of corresponding search features 342 in one or more of the search frames 320 makes up a search point sequence 350. The search point sequence 350 can be obtained by selecting a search feature 342A in a selected search frame 320A, followed by adding matching search features 342 in other search frames 320.

Reference features 242 and search features 342 can be identified using machine vision and/or artificial intelligence methods, and the like. Suitable methods include feature detection, extraction and/or matching techniques such as RANSAC (RANdom SAmple Consensus), Shi & Tomasi corner detection, SURF blob (Speeded Up Robust Features) detection, MSER blob (Maximally Stable Extremal Regions) detection, SURF (Speeded Up Robust Features) descriptors, SIFT (Scale-Invariant Feature Transform), FREAK (Fast REtinA Keypoint) descriptors, BRISK (Binary Robust Invariant Scalable Keypoints) descriptors, HOG (Histogram of Oriented Gradients) descriptors, and the like. Size and shape filtered can be applied to feature identification, as desired.

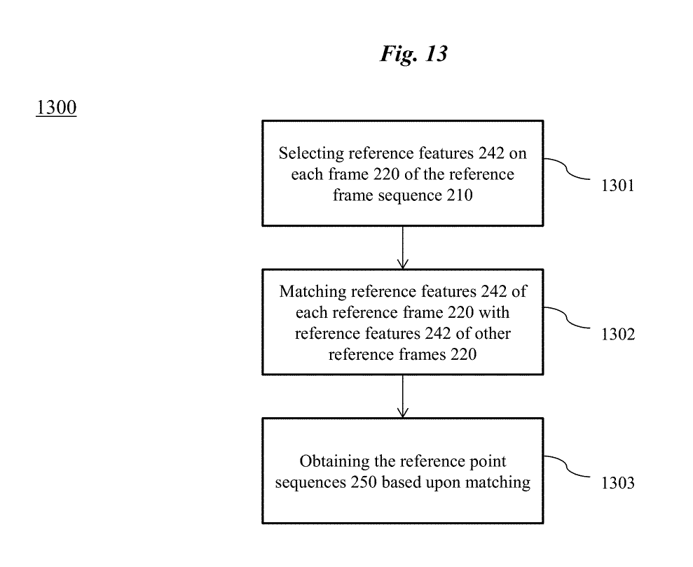

Turning now to FIG. 13, an exemplary method 1300 is shown for obtaining a reference point sequence 250 based on selection of reference features 242. At 1301, one or more reference features 242 are selected on each reference frame 220 of a reference frame sequence 210. Similarly to the selection of reference point sequences 250 described above with reference to FIG. 7, the number of reference features 242 (and corresponding reference point sequences 250) that are selected can vary depending on the size and complexity of the reference frames 220. For example, the number of reference features 242 that are selected can be 1, 2, 5, 10, 20, 50, 100, 200, 500, 1000, 2000, 5000, 10,000, 20,000, 50,000, 100,000, or even more. At 1302, reference features 242 of each reference frame 220 are matched with reference features 242 of other reference frames 220. In some embodiments, a particular reference feature 242 will have a match in each of the reference frames 220. In other embodiments, the particular reference feature 242 will have a match in each of some but not all of the reference frames 220. The matching can be performed using, for example, a SIFT (Scale-Invariant Feature Transform) technique. Finally, at 1303, a reference point sequence 250 can be obtained based on the matching.

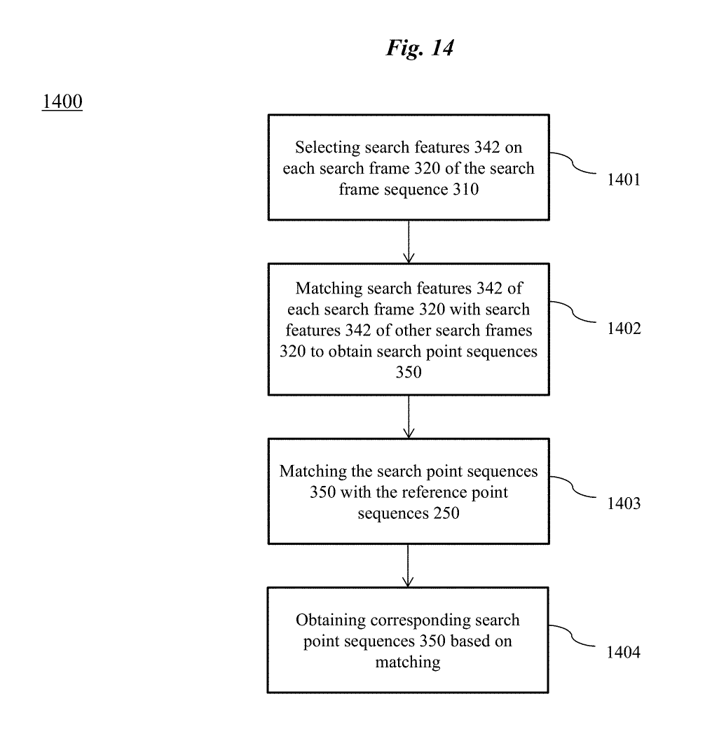

Turning now to FIG. 14, an exemplary method 1400 is shown for matching reference point sequences 250 with corresponding search point sequences 350 for video synchronization. At 1401, one or more search features 342 are selected on each search frame 320 of a search frame sequence 310. Similarly to the selection of search point sequences 350 described above with reference to FIG. 7, the number of search features 342 (and corresponding search point sequences 350) that are selected can vary depending on the size and complexity of the search frames 320. For example, the number of search features 342 that are selected can be 1, 2, 5, 10, 20, 50, 100, 200, 500, 1000, 2000, 5000, 10,000, 20,000, 50,000, 100,000, or even more. At 1402, one or more search features 342 of each search frame 320 is matched with search features 342 of other search frames 320 to obtain one or more search point sequences 350. In some embodiments, a particular search feature 342 will have a match in each of the search frames 320. In other embodiments, the particular search feature 342 will have a match in each of some, but not all, of the search frames 320. The matching can be performed using, for example, a SIFT (Scale-Invariant Feature Transform) technique. At 1403, the search point sequences 350 can be matched with corresponding reference point sequence 250. The matching can be based, for example, on similarity of image data between the search point sequence 350 and the reference point sequence 250. Finally, at 1404, the search point sequences 350 that correspond to each of the reference point sequences 250 are obtained based on the matching.

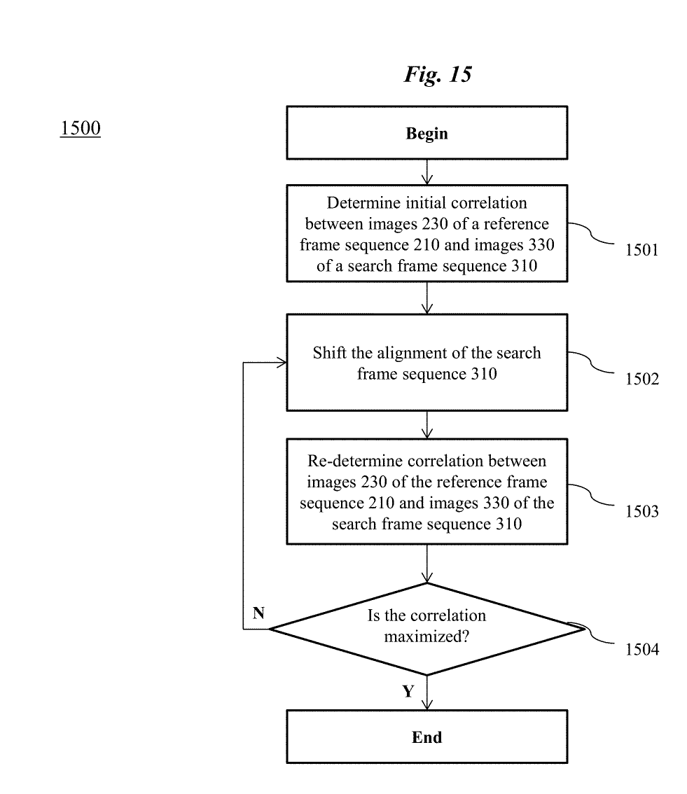

Turning now to FIG. 15, an exemplary method 1500 is shown for video synchronization by iteratively shifting the alignment of search frames 320 of a search frame sequence 310 to optimize a correlation between the search frame sequence 310 and a reference frame sequence 210. Beginning at 1501, an initial alignment of the search frame sequence 310 is made with respect to the reference frame sequence 210. An initial correlation between images 230 of the reference frame sequence 210 and images 330 of the search frame sequence 310 in the initial alignment can be determined. At 1502, the search frame sequence 310 is shifted using any suitable technique. For example, the search frame sequence 310 can be shifted forward or backward by a certain number of search frames 320.

At 1503, a correlation can be determined between images 230 of the reference frame sequence 210 and images of the search frame sequence 310 in the shifted alignment. For example, the correlation can be a Pearson correlation coefficient, a covariance, or other suitable metric of a correlation between two sets of numerical values. In some embodiments, a correlation can be determined between image data 230 of reference point sequences 250 and image data 330 of corresponding search point sequences. Finally, at 1504, whether the correlation is maximized is determined. If the correlation is maximized, the method ends, as an optimum synchronization between the reference frame sequence 210 and the search frame sequence 310 will have been found. Otherwise, if the correlation is not maximized, the search frame sequence 310 can be shifted again at 1502, and the optimization process for video synchronization can continue. Any suitable optimization process can be used for video synchronization according to the systems and methods described herein. Suitable optimization methods for optimization the correlation include, for example, linear optimization methods, non-linear optimization methods, least square methods, gradient descent or ascent methods, hill-climbing methods, simulated annealing methods, genetic methods, and the like.

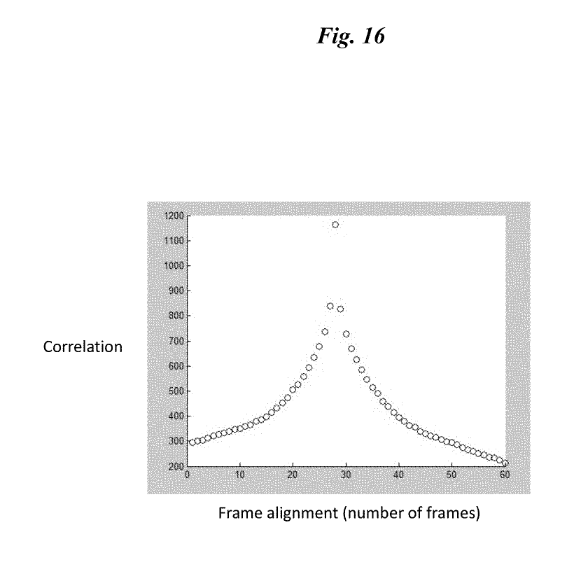

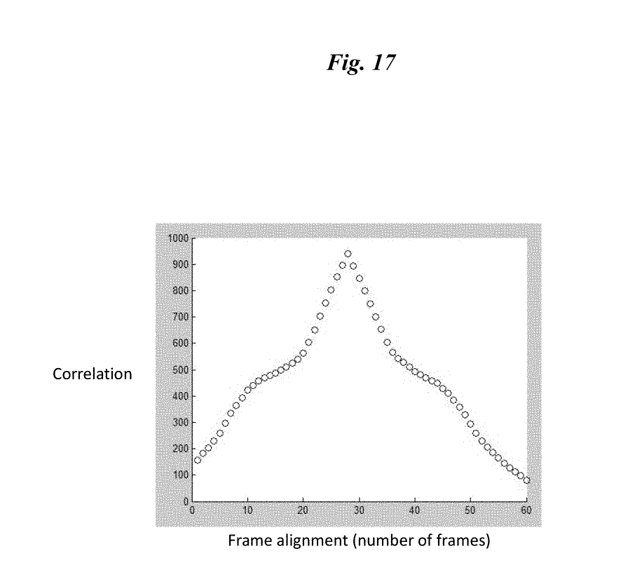

In particular, the optimization process can take advantage of the fact that correlation profiles between image data of a reference frame sequence 210 and a search frame sequence 310 often have a single maximum, rather than multiple local maxima. For example, FIG. 16 shows an exemplary plot of experimental correlations between the reference frame sequence 210 and the search frame sequence 310. The horizontal axis of the plot is the relative alignment (in number of frames) between the reference frame sequence 210 and the search frame sequence 310. The vertical axis of the plot is the correlation. As shown in the plot, the correlation takes on a single maximum peak. Similarly, FIG. 17 shows another exemplary plot with a different set of data showing experimental correlations between the reference frame sequence 210 and the search frame sequence 310. The correlation similarly takes on a single maximum peak in the plot of FIG. 17. Therefore, in some embodiments, the correlation optimization (or maximization) process can take initially large steps (in terms of number of frames), following by smaller steps as the maximum correlation is approach or passed. This optimization process can advantageously reduce the number of steps taken (in other words, reduce the number of frame sequences compared) for video synchronization.

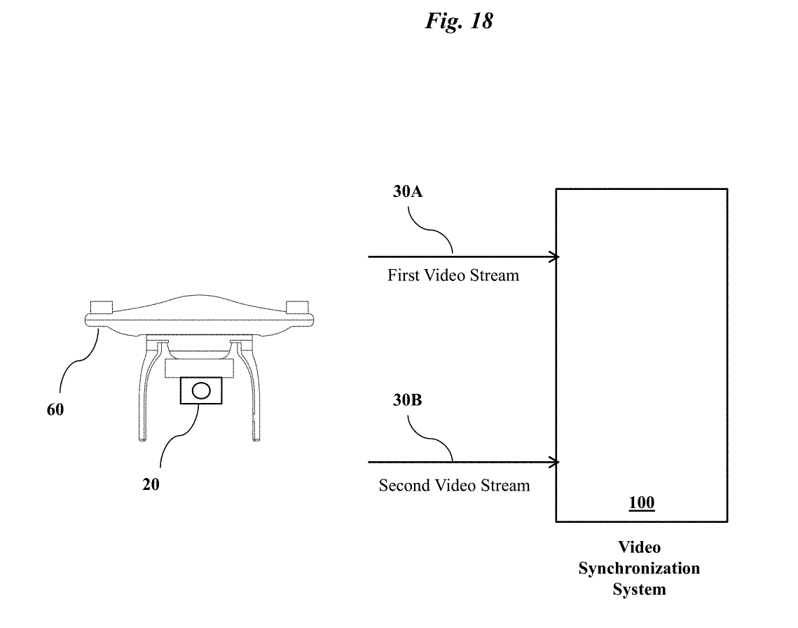

Video synchronization according to the present systems and methods can be applied to video streams taken by mobile platforms. In some embodiments, the mobile platform is an unmanned aerial vehicle (UAV) 60. For example, FIG. 18 shows an imaging device 20 that is mounted aboard a UAV 60. UAVs 60, colloquially referred to as “drones,” are aircraft without a human pilot onboard the vehicle whose flight is controlled autonomously or by a remote pilot (or sometimes both). UAVs 60 are now finding increased usage in civilian applications involving various aerial operations, such as data-gathering or delivery. One or more video streams 30 (for example, a first video stream 30A and/or a second video stream 30B) can be delivered from the UAV 60 to a video synchronization system 100. The present video synchronization systems and methods are suitable for use with many types of UAVs 60 including, without limitation, quadcopters (also referred to a quadrotor helicopters or quad rotors), single rotor, dual rotor, trirotor, hexarotor, and octorotor rotorcraft UAVs, fixed wing UAVs, and hybrid rotorcraft-fixed wing UAVs. Other suitable mobile platforms for use with the present video synchronization systems and methods include, but are not limited to, bicycles, automobiles, trucks, ships, boats, trains, helicopters, aircraft, various hybrids thereof, and the like.

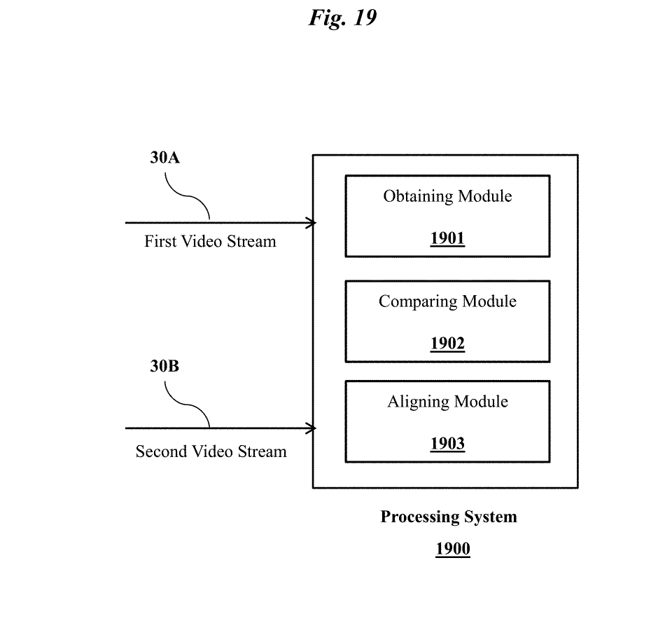

Turning now to FIG. 19, an exemplary processing system 1900 is shown as including one or more modules to perform any of the methods disclosed herein. The processing system 1900 is shown as including an obtaining module 1901, a comparing module 1902, and an aligning module 1903. In some embodiments, the obtaining module 1901 can be configured for obtaining image data 230 (shown in FIG. 3) from a reference frame sequence 210 (shown in FIG. 3) and corresponding image data 330 (shown in FIG. 3) of a search frame sequence 310 (shown in FIG. 3), the comparing module 1902 can be configured for comparing the image data 230 from the reference frame sequence 210 with the corresponding image data 330 of the search frame sequence 310, and the aligning module 1903 can be configured for aligning the search frame sequence 310 with the reference frame sequence 210 based on the compared image data 230, 330. In some embodiments, the comparing module 1901 can be configured to compare the image data 230 between the reference frame sequence 210 of a first video stream 30A with the corresponding image data 330 from the search frame sequence 310 of a second video stream 30B. In some embodiments, the comparing module 1901 can be configured to obtain one or more reference point sequences 250 (shown in FIG. 6) from the reference frame sequence 210, obtain one or more search point sequences 350 (shown in FIG. 6) from the search frame sequence 310 corresponding to the reference point sequences 250, and compare image data between the reference point sequences 250 and the corresponding search point sequences 350.

In some embodiments, the first video stream 30A and the second video stream 30B can be received from a common imaging device 20 (shown in FIG. 1). The comparing module 1901 can be configured to obtain each of the reference point sequences 250 by selecting a reference pixel 241 (shown in FIG. 9) on a selected frame 220 of the reference frame sequence 210, locate one or more matching reference pixels 341 on one or more other frames 220 of the reference frame sequence 210, and obtain the reference point sequence 210 as a sequence of the selected reference pixel 241 and the matching reference pixels 241. The comparing module 1901 can be configured to locate the matching reference pixels 241 on frames 220 of the reference frame sequence 210 based on coordinates of the selected reference pixel 241. The reference point sequences 250 can be selected in any desired pattern, such as a grid pattern and/or a random pattern. The reference points 240 can be selected in a center of the respective frame 220 of the reference frame sequence. Each of the corresponding search point sequences 350 can be obtained based on coordinates of the corresponding reference point sequence 250.

In some embodiments, the first video stream 30A and the second video stream 30B can be received from different imaging devices 20. The comparing module 1901 can be configured to obtain the reference point sequences 250 by selecting a plurality of reference features 242 (shown in FIG. 12) on each frame 220 of the reference frame sequence 210, match reference features 242 of each frame 210 of the reference frame sequence 210 with reference features 242 of other frames 210 of the reference sequence 210, and obtain the reference point sequences 250 based upon the matching. The comparing module 1901 can be further configured to obtain the search point sequences 350 by selecting a plurality of search features 342 on each frame 320 of the search frame sequence 310, match the selected search features 342 with the selected features 342 of other frames 320 of the search frame sequence 310 to obtain the search point sequences 350, match the search point sequences 350 with the reference point sequences 250, and obtain the corresponding search point sequences 350 based upon the matching. The plurality of features 242, 342 on each frame 220, 320 of the reference frame sequence 210 and/or the search frame sequence 310 can be selected, for example, using a scale-invariant feature transform (SIFT) technique.

In some embodiments, the comparing module 1901 can be configured to determine a correlation between image data 230 of the reference point sequences 210 and image data 330 of the search point sequences 310. The comparing module 1901 can be configured to compare mosaic and/or non-mosaic image data 230, 330 of the reference frame sequence 210 and the search frame sequence 310.

In some embodiments, the comparing module 1901 can be configured determine a correlation between image data 230 of the reference point sequences 350 and image data 330 of the search point sequences 350. In some embodiments, the aligning module 1902 can be configured to determine an alignment of the search frame sequence 310 with the reference frame sequence 310 that maximizes the correlation. The aligning module 1902 can be configured to maximize the correlation by any desired optimization technique, such as gradient ascent.

In some embodiments, the obtaining module 1903 can be configured to obtain the first video stream and the second video stream from a mobile platform 60 (shown in FIG. 18), such as an unmanned aerial vehicle (UAV).

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A method of video synchronization, comprising:
comparing image data from a reference frame sequence with corresponding image data of a search frame sequence; and
aligning the search frame sequence with the reference frame sequence based on the comparing.

2. The method of claim 1, wherein comparing the image data from the reference frame sequence with the corresponding image data of the search frame sequence comprises:
obtaining one or more reference point sequences from the reference frame sequence;
obtaining one or more search point sequences from the search frame sequence corresponding to the one or more reference point sequences; and
comparing image data of the one or more reference point sequences with corresponding image data of the one or more search point sequences.

3. The method of claim 2, wherein obtaining the one or more reference point sequences comprises, for one reference point sequence of the one or more reference point sequences:
selecting a reference pixel on a selected frame of the reference frame sequence;
locating one or more matching reference pixels on one or more other frames of the reference frame sequence; and
obtaining the one reference point sequence as a sequence of the selected reference pixel and the one or more matching reference pixels.

4. The method of claim 3, wherein locating the one or more matching reference pixels comprises locating the one or more matching reference pixels on one or more frames of the reference frame sequence based on coordinates of the selected reference pixel.

5. The method of claim 2, wherein obtaining the one or more search point sequences comprises, for one search point sequence of the one or more search point sequences, obtaining the one search point sequence based on coordinates of a corresponding reference point sequence of the one or more reference point sequences.

6. The method of claim 1, wherein comparing the image data from the reference frame sequence with the corresponding image data of the search frame sequence comprises comparing the image data from the reference frame sequence of a first video stream with the corresponding image data of the search frame sequence of a second video stream.

7. The method of claim 6, further comprising:
receiving the first video stream and the second video stream from a common imaging device.

8. The method of claim 6, further comprising:
receiving the first video stream and the second video stream from different imaging devices,
wherein comparing the image data from the reference frame sequence with the corresponding image data of the search frame sequence comprises:
obtaining one or more reference point sequences from the reference frame sequence;
obtaining one or more search point sequences from the search frame sequence corresponding to the one or more reference point sequences; and
comparing image data from the one or more reference point sequences with corresponding image data from the one or more search point sequences.

9. The method of claim 8, wherein obtaining the one or more reference point sequences comprises:
selecting a plurality of reference features on each frame of the reference frame sequence;
matching reference features of each frame of the reference frame sequence with reference features of other frames of the reference frame sequence; and
obtaining the one or more reference point sequences based upon the matching.

10. The method of claim 8, wherein obtaining the one or more search point sequences comprises:
selecting a plurality of search features on each frame of the search frame sequence;
matching the selected search features of each frame of the search frame sequence with selected features of other frames of the search sequence to obtain the one or more search point sequences;
matching the one or more search point sequences with the one or more reference point sequences; and
obtaining the one or more search point sequences based upon matching the one or more search point sequences with the one or more reference point sequences.

11. The method of claim 1, wherein aligning the search frame sequence with the reference frame sequence comprises determining an alignment of the search frame sequence with the reference frame sequence that maximizes a correlation between image data of one or more reference point sequences obtained from the reference frame sequence and corresponding image data from one or more search point sequences obtained from the search frame sequence.

12. A video synchronization system, comprising:
one or more sensors configured to receive a first video stream and a second video stream; and
a processor configured to:
obtain a reference frame sequence from the first video stream and a search frame sequence from the second video stream;
compare image data from the reference frame sequence with corresponding image data of the search frame sequence; and
align the search frame sequence with the reference frame sequence based on the comparing.

13. The video synchronization system of claim 12, wherein the processor is further configured to:
obtain one or more reference point sequences from the reference frame sequence;
obtain one or more search point sequences from the search frame sequence corresponding to the one or more reference point sequences; and
compare image data of the one or more reference point sequences with corresponding image data of the one or more search point sequences.

14. The video synchronization system of claim 13, wherein the video synchronization system is configured to receive the first video stream and the second video stream from a common imaging device.

15. The video synchronization system of claim 13, wherein the processor is configured to obtain the one or more reference point sequences by, for one reference point sequence of the one or more reference point sequences:
selecting a reference pixel on a selected frame of the reference frame sequence;
locating one or more matching reference pixels on one or more other frames of the reference frame sequence; and
obtaining the one reference point sequence as a sequence of the selected reference pixel and the matching reference pixels.

16. The video synchronization system of claim 15, wherein the processor is further configured to locate the one or more matching reference pixels by locating the one or more matching reference pixels on one or more frames of the reference frame sequence based on coordinates of the selected reference pixel.

17. The video synchronization system of claim 13, wherein the processor is configured to obtain the one or more reference point sequences by:
selecting a plurality of reference features on each frame of the reference frame sequence;
matching reference features of each frame of the reference frame sequence with reference features of other frames of the reference frame sequence; and
obtaining the one or more reference point sequences based upon the matching.

18. The video synchronization system of claim 13, the processor is configured to obtain the one or more search point sequences by:
selecting a plurality of search features on each frame of the search frame sequence;
matching the selected search features of each frame of the search frame sequence with the selected features of other frames of the search sequence to obtain the one or more search point sequences;
matching the one or more search point sequences with the one or more reference point sequences; and
obtaining the one or more search point sequences based upon matching the one or more search point sequences with the one or more reference point sequences.

19. The video synchronization system of claim 12, wherein the reference frame sequence and the search frame sequence have a substantially same frame rate.

20. The video synchronization system of claim 12, wherein the one or more sensors are configured to obtain the first video stream and the second video stream from a mobile platform.
